(19) United States
(12) Patent Application Publication
(10) Pub. No.: US 2009/0131059 A1
(43) Pub. Date: May 21, 2009

(54) COMMUNICATION METHOD AND SYSTEM, DATA TRANSMISSION METHOD AND SYSTEM, AND COMMUNICATION MODE COMBINATION METHOD AND SYSTEM

(75) Inventors: Sheng LIU, Shenzhen (CN); Wei RUAN, Shenzhen (CN); Yinggang DU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/359,045

(22) Filed: Jan. 23, 2009

Related U.S. Application Data
(63) Continuation of application No. PCT/CN2007/070354, filed on Jul. 25, 2007.

(30) Foreign Application Priority Data
Jul. 26, 2006 (CN) 200610099514.2

(51) Int. Cl. H04W 36/00

(52) U.S. Cl. 455/442

(57) ABSTRACT

A communication method based on a plurality of softer handoff groups is provided, which includes: dividing various services into different characteristic services according to characteristics of the services; and selecting at least one softer handoff group as a serving cell of a terminal according to the characteristic services subscribed by the terminal. A communication system, a data transmission method and a data transmission system, and a communication mode combination method and a communication mode combination system based on a plurality of softer handoff groups are further provided. With the above technical solutions, through selecting a plurality of softer handoff cells as the serving cell, the requirement of simultaneous transmission of wideband service data is satisfied and the system efficiency is enhanced, thereby improving the resource utilization rate.

### CROSS-REFERENCE TO RELATED APPLICATIONS

This application is a continuation of International Patent Application No. PCT/CN2007/070354, filed Jul. 25, 2007, which claims priority to Chinese Patent Application No. 200610099514.2, filed Jul. 26, 2006, both of which are hereby incorporated by reference in their entirety.

### FIELD OF THE INVENTION

The present invention relates to the field of communication, and more particularly, to a communication method and system, a data transmission method and system, and a communication mode combination method and system based on a plurality of softer handoff groups, applicable to a wireless cellular communication system, for example.

### BACKGROUND

With the rapid development of network technology and mobile communication technology, the demand for a high speed and high quality wireless communication service is considerably increased. A mobile communication terminal needs to support not only traditional low-speed real-time services, such as a voice service, but also high-speed large-bandwidth data services, such as file transmission and webpage downloading. In a post-3G wireless communication system, a communication system is required to provide all the above services at the same time. In order to enhance the communication quality for subscribers at the edge of a cell, improve system capacity, decrease the dropping rate of real-time services due to frequent handoffs, and guarantee the communication quality of real-time services, the softer handoff group (SHOG) technology may be employed.

The SHOG is also called a group cell, which means that among a plurality of geographically neighboring cells, the same set of communication resources such as a frequency, timeslot, or code channel is adopted for one mobile terminal to communicate, and the other sets of communication resources are respectively adopted for the other mobile terminals to communicate. When the number of cells constituting the SHOG is one, the communication technology is the same as the single cell communication technology before the SHOG technology appears. Therefore, broadly speaking, the traditional single cell communication technology is a special example of the SHOG (the SHOG technology mentioned hereinafter includes the traditional single cell communication technology). The SHOG communication technology has made up for some drawbacks of the traditional wireless cellular communication technology. However, as for a mobile terminal subscribing different characteristic services at the same time, it cannot achieve optimum effects through the SHOG technology in the existing systems.

A technology relevant to the present invention proposes a method for constructing a cell group. In other words, among a plurality of geographically neighboring cells, the same set of communication resources, such as a frequency, timeslot, or code channel, is adopted to communicate with one mobile terminal, and other different sets of communication resources are respectively adopted to communicate with the other mobile terminals. As for each mobile terminal, the signals emitted from each cell in the cell group in communication with the mobile terminal may be the same or different. Since the cells adopt the same set of communication resources for the same mobile terminal, some technologies in the physical layer of the wireless communication system may be used such as a joint transmission technology or distributed antenna technology. During such a process, the terminal can easily achieve a soft handoff process, and meanwhile achieve a softer handoff among different sectors, and thus, such a technology is also called SHOG technology. In other words, a plurality of neighboring sectors is divided into one group for each terminal, and then the same set of communication resources such as a frequency, timeslot, or code channel is adopted for one mobile terminal to communicate, and other different sets of communication resources are respectively used for the other mobile terminals to communicate. The group division is not constant, but adjustable.

In the above technical solution, one mobile terminal is served by a single SHOG at a certain time. However, in some cases, for example, one mobile terminal subscribes a plurality of services with different characteristics such as a large-bandwidth data service insensitive to delays and a low-speed service with a high real time requirement, considerable channel resources may be wasted if the mobile terminal is served by only one SHOG. That is because the large-bandwidth service needs to be allocated with more channel resources, and with the SHOG technology, each base station in the SHOG needs to allocate such channel resources for the large-bandwidth service, which severely influences the service offered by the system to the other services and user terminals, thereby resulting in an excessive consumption of bandwidth and a deteriorated system efficiency. Furthermore, as each cell has a different load, the cell having a light load may allocate a large bandwidth to the subscriber for meeting the requirement of a large-bandwidth service, whereas the cell with a large load may allocate only a small bandwidth to the subscriber for providing only a low-speed service. Therefore, in order to optimize the system, a plurality of SHOGs can be respectively adopted for different services of the mobile terminal.

As known from the above descriptions, the technical solution above cannot meet the requirement of a terminal that subscribes services with various different characteristics at the same time. Therefore, if one mobile terminal subscribes services with various characteristics at the same time, such as a large-bandwidth data service and a low-speed service with a high real time requirement, the approach of using a single SHOG to serve the mobile terminal may deteriorate the system efficiency and decrease the resource utilization rate.

Therefore, a communication method, a communication system, and a mechanism based on a plurality of SHOGs capable of overcoming many drawbacks of the technical solutions in the existing systems are needed.

### SUMMARY

Embodiments of the present invention provide a communication method and a communication system, a data transmission method and a data transmission system, and a communication mode combination method and a communication mode combination system based on a plurality of softer handoff groups, in which a plurality of softer handoff groups are selected as serving cells of a terminal, so as to improve a system efficiency and thus enhance the resource utilization rate.

Embodiments of the present invention provide a communication method based on a plurality of softer handoff groups.

The communication method based on a plurality of softer handoff groups according to the present invention includes:

dividing various services into different characteristic services according to characteristics of the services; and

selecting at least one softer handoff group as a serving cell of a terminal according to characteristic services subscribed by the terminal.

Embodiments of the present invention provide a communication system based on a plurality of softer handoff groups.

The communication system based on a plurality of softer handoff groups according to the present invention includes:

a characteristic service determination module, adapted to divide various services into different characteristic services according to characteristics of the services; and

a serving cell selection module, adapted to select at least one softer handoff group as a serving cell of a terminal according to characteristic services subscribed by the terminal.

Embodiments of the present invention provide a data transmission method based on a plurality of softer handoff groups.

In the data transmission method based on a plurality of softer handoff groups according to the present invention, at least one softer handoff group is selected as a serving cell for transmitting uplink data or downlink data of terminal services. Particularly, the single cell is a softer handoff group with only one cell.

Embodiments of the present invention provide a data transmission system based on a plurality of softer handoff groups.

The data transmission system based on a plurality of softer handoff groups according to the present invention includes a serving cell selection module adapted to select at least one softer handoff group as a serving cell for transmitting uplink data or downlink data of terminal services. Particularly, the single cell is a softer handoff group with only one cell.

Embodiments of the present invention provide a communication mode combination method based on a plurality of softer handoff groups.

In the communication mode combination method based on a plurality of softer handoff groups according to the present invention, at least one control signaling and service data for terminal services are transmitted by means of a communication mode of a softer handoff group and a communication mode of a single cell.

Embodiments of the present invention provide a communication mode combination system based on a plurality of softer handoff groups.

The communication mode combination system based on a plurality of softer handoff groups according to the present invention includes a communication mode combination module adapted to transmit at least one control signaling and service data of terminal services by means of a communication mode of a softer handoff group and a communication mode of a single cell.

Through the above technical solutions, the present invention achieves the following efficacies. By selecting a plurality of softer handoff groups as serving cells, the requirement of simultaneous transmission of wideband service data is satisfied and the system efficiency is enhanced, thereby improving the resource utilization rate.

### BRIEF DESCRIPTION OF THE DRAWINGS

The present invention will become more fully understood from the detailed descriptions given below for illustration only, which thus is not limitative of the present invention.

FIG. 1 is a flow chart of a communication method based on a plurality of softer handoff groups according to a first embodiment of the present invention;

FIG. 2 is a block diagram of a communication system based on a plurality of softer handoff groups according to a second embodiment of the present invention;

FIG. 3 is a block diagram of a data transmission system based on a plurality of softer handoff groups according to a fourth embodiment of the present invention; and

FIG. 4 is a block diagram of a communication mode combination system based on a plurality of softer handoff groups according to a sixth embodiment of the present invention.

### DETAILED DESCRIPTION

In the following, preferred embodiments of the present invention are described in detail with reference to the accompanying drawings, which form a part of the present invention and are used together with the embodiments of the present invention to explain the principles of the present invention.

### Embodiment 1

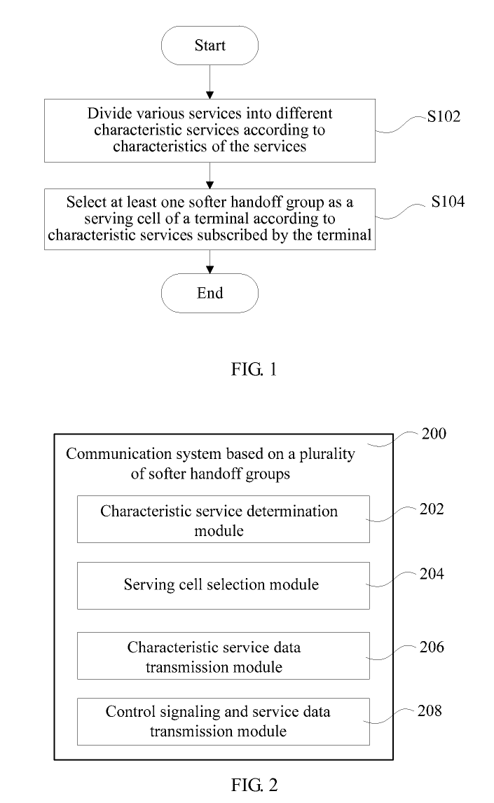

In the first embodiment of the present invention, a communication method based on a plurality of softer handoff groups is provided. The embodiment is described below with reference to FIG. 1. FIG. 1 is a flow chart of a communication method based on a plurality of softer handoff groups according to a first embodiment of the present invention.

As shown in FIG. 1, the communication method based on a plurality of softer handoff groups according to the present invention includes the following steps. In Step S102, various services are divided into different characteristic services according to characteristics of the services; and in Step S104, at least one softer handoff group is selected as a serving cell of a terminal according to characteristic services subscribed by the terminal. At least one softer handoff group is selected as the serving cell, so that an overall scheduling can be implemented according to the load of the cells in each softer handoff group and the various service characteristics of the terminal.

The characteristics of the services include a bandwidth, quality of service, or a real-time capability, and the like.

In the event that the terminal subscribes a plurality of characteristic services, a plurality of softer handoff groups with a number corresponding to that of the characteristic services is selected as the serving cell of the terminal in Step S104. For example, as for a large-bandwidth data service and file download, softer handoff groups with cells having light loads are selected as the serving cell. For example, the large bandwidth usually refers to a bandwidth larger than 200 k/bits and the light load refers to, such as the lightest load among those of all cells, or a load lighter than the heaviest load among those of all cells. In this way, each cell in the softer handoff groups may provide a large bandwidth to the terminal. By selecting different softer handoff groups as the serving cell for different services of the terminal, the system efficiency can be improved, and the requirements of different services can be met as well.

In addition, the terminal sends a plurality of characteristic service data over a channel resource by means of a plurality of channel multiplexing modes, and meanwhile, a base station determines a softer handoff group to which the characteristic service data belong according to the corresponding channel resource, so as to demodulate corresponding data. Or, the base station sends a plurality of characteristic service data over a channel resource by means of a plurality of channel multiplexing modes, and meanwhile, the terminal determines a softer handoff group to which the characteristic service data belong according to the corresponding channel resource, so as to demodulate corresponding data. The channel multiplexing modes include, but are not limited to, a frequency division multiplexing mode, a time division multiplexing mode, a code division multiplexing mode, and a composite multiplexing mode.

For example, by means of the frequency division multiplexing mode, a plurality of characteristic service data are respectively modulated on different sub-carriers for being sent. The base station determines a softer handoff group to which the data belong according to the corresponding sub-carrier and demodulates the corresponding data by means of a corresponding joint detection technology. Furthermore, with the time division multiplexing mode, a plurality of characteristic service data are sent through different timeslots. The base station determines a softer handoff group to which the data belong according to the corresponding timeslot and demodulates the corresponding data by means of a corresponding joint detection technology.

As for a terminal subscribing one or more characteristic services, a softer handoff group or a single cell may be selected as the serving cell for transmitting uplink data or downlink data for the characteristic services of the terminal. For example, a softer handoff group is selected as the serving cell for transmitting uplink data and a single cell is selected as the serving cell for transmitting downlink data. Or, a single cell is selected as the serving cell for transmitting uplink data and a softer handoff group is selected as the serving cell for transmitting downlink data. The single cell here refers to a softer handoff group with only one cell.

Similarly, as for a terminal subscribing one or more characteristic services, at least one control signaling or service data for the characteristic services of the terminal may be transmitted by means of a communication mode of a softer handoff group or a communication mode of a single cell. The communication mode of the softer handoff group refers to a mode in which a wireless access network utilizes the same resources of a plurality of cells to communicate with the terminal, and the communication mode of the single cell refers to a mode in which the wireless access network utilizes the communication resources of a single cell to communicate with the terminal. The communication resources include a frequency, a timeslot, and a code channel. For example, downlink service data are transmitted by means of the communication mode of the softer handoff group and at least one downlink control signaling is transmitted by means of the communication mode of the single cell. Or, uplink service data are transmitted by means of the communication mode of the softer handoff group and at least one uplink control signaling is transmitted by means of the communication mode of the single cell.

### Embodiment 2

In a second embodiment of the present invention, a communication system based on a plurality of softer handoff groups is provided. This embodiment is described below with reference to FIG. 2. FIG. 2 is a block diagram of a communication system based on a plurality of softer handoff groups according to a second embodiment of the present invention.

As shown in FIG. 2, a communication system 200 based on a plurality of softer handoff groups in this embodiment includes: a characteristic service determination module 202, adapted to divide various services into different characteristic services according to characteristics of the services; and a serving cell selection module 204, adapted to select at least one softer handoff group as a serving cell of a terminal according to characteristic services subscribed by the terminal. A plurality of softer handoff groups are selected as the serving cells, so that an overall scheduling can be implemented according to the loads of the cells in each softer handoff group and various service characteristics of the terminal.

The characteristics of the services include a bandwidth, quality of service, or a real-time capability, and the like.

In the event that the terminal subscribes a plurality of characteristic services, the serving cell selection module 204 selects a plurality of softer handoff groups with a number corresponding to that of the characteristic services of the terminal as the serving cell for the terminal. For example, as for a large-bandwidth data service and file download, and the like, a softer handoff group with cells having light loads is selected as the serving cell. In this way, each cell in the softer handoff group can provide a large bandwidth to the terminal. Therefore, by selecting different softer handoff groups as the serving cell directed to different services of the terminal, the system efficiency can be improved, and the requirements of different services can be met as well.

As for a terminal subscribing one or more characteristic services, the communication system 200 in this embodiment further includes at least one characteristic service data transmission modules 206, respectively located on a terminal side and a base station side, and adapted to send at least one characteristic service data over a channel resource from one side by means of a plurality of channel multiplexing modes and determine a softer handoff group to which the characteristic service data belongs according to the corresponding channel resource to demodulate corresponding data on the other side. The channel multiplexing modes include, but are not limited to, a frequency division multiplexing mode, a time division multiplexing mode, a code division multiplexing mode, or a composite multiplexing mode.

As for a terminal subscribing one or more characteristic services, the serving cell selection module 204 may select a softer handoff group or a single cell as the serving cell for transmitting uplink data or downlink data for the characteristic services of the terminal. For example, the serving cell selection module 204 may select a softer handoff group as the serving cell for transmitting uplink data and select a single cell as the serving cell for transmitting downlink data. Or, the serving cell selection module 204 may select a single cell as the serving cell for transmitting uplink data and select a softer handoff group as the serving cell for transmitting downlink data. The single cell here refers to a softer handoff group with only one cell.

Furthermore, as for a terminal subscribing one or more characteristic services, the communication system 200 in this embodiment further includes a control signaling and service data transmission module 208 adapted to transmit at least one control signaling or service data for the characteristic services of the terminal by means of a communication mode of a softer handoff group or a communication mode of a single cell.

The communication mode of the softer handoff group refers to a mode in which the wireless access network utilizes the same resources of a plurality of cells to communicate with the terminal, and the communication mode of the single cell refers to a mode in which the wireless access network utilizes the communication resources of a single cell to communicate with the terminal. The communication resources include a frequency, a timeslot, and a code channel. For example, the control signaling and service data transmission module 208 may transmit downlink service data by means of the communication mode of the softer handoff group and transmit at least one downlink control signaling by means of the communication mode of the single cell. Or, the control signaling and service data transmission module 208 may transmit uplink service data by means of the communication mode of the softer handoff group and transmit at least one uplink control signaling by means of the communication mode of the single cell.

### Embodiment 3

In a third embodiment according to the present invention, a data transmission method based on a plurality of softer handoff groups is provided.

In the data transmission method based on a plurality of softer handoff groups in this embodiment, a plurality of softer handoff groups are selected as serving cells for transmitting uplink data or downlink data of terminal services. Particularly, the single cell is a softer handoff group with only one cell.

The characteristics of data transmitted via the uplink and downlink are not symmetric for some services. Taking a file download service as an example, the downlink involves a large-bandwidth data service and has a high requirement for the bandwidth of the cells in a softer handoff group, whereas the uplink only involves some services associated with control commands like mouse clicking and has a moderate requirement for the bandwidth of the cells in the softer handoff group. Therefore, even for the same service, the uplink data and downlink data may be transmitted by selecting different softer handoff groups as the serving cells.

For example, a softer handoff group is selected as the serving cell for transmitting uplink data, and a single cell is selected as the serving cell for transmitting downlink data. Or, a single cell is selected as the serving cell for transmitting uplink data, and a softer handoff group is selected as the serving cell for transmitting downlink data.

### Embodiment 4

In a fourth embodiment according to the present invention, a data transmission system based on a plurality of softer handoff groups is provided.

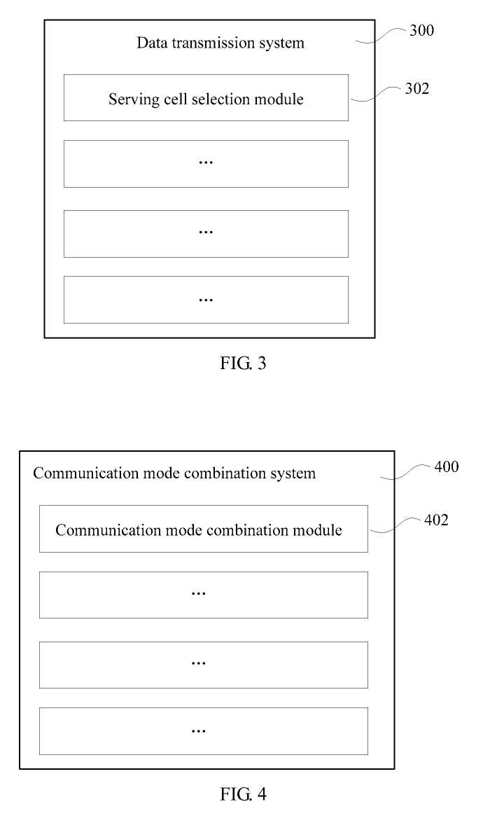

As shown in FIG. 3, a data transmission system 300 based on a plurality of softer handoff groups in this embodiment mainly includes a serving cell selection module 302 adapted to select a plurality of softer handoff groups as serving cells for transmitting uplink data or downlink data of terminal services. Particularly, the single cell is a softer handoff group with only one cell.

For example, the serving cell selection module 302 may select a softer handoff group as the serving cell for transmitting uplink data and select a single cell as the serving cell for transmitting downlink data. Or, the serving cell selection module 302 may select a single cell as the serving cell for transmitting uplink data and select a softer handoff group as the serving cell for transmitting downlink data.

### Embodiment 5

In a fifth embodiment according to the present invention, a communication mode combination method based on a plurality of softer handoff groups is provided.

In the communication mode combination method based on a plurality of softer handoff groups in this embodiment, at least one control signaling and service data of terminal services is transmitted by means of a communication mode of a softer handoff group and a communication mode of a single cell.

The communication mode of the softer handoff group refers to a mode in which the wireless access network utilizes the same resources of a plurality of cells to communicate with the terminal, and the communication mode of the single cell refers to a mode in which the wireless access network utilizes the communication resources of a single cell to communicate with the terminal. The communication resources include a frequency, a timeslot, and a code channel.

For example, downlink service data are transmitted by means of the communication mode of the softer handoff group and at least one downlink control signaling is transmitted by means of the communication mode of the single cell. Or, uplink service data are transmitted by means of the communication mode of the softer handoff group and at least one uplink control signaling is transmitted by means of the communication mode of the single cell.

### Embodiment 6

In a sixth embodiment according to the present invention, a communication mode combination system based on a plurality of softer handoff groups is provided.

As shown in FIG. 4, a communication mode combination system 400 based on a plurality of softer handoff groups in this embodiment mainly includes a communication mode combination module 402 adapted to transmit at least one control signaling and service data of terminal services by means of a communication mode of a softer handoff group and a communication mode of a single cell.

The communication mode of the softer handoff group refers to a mode in which the wireless access network utilizes the same resources of a plurality of cells to communicate with the terminal, and the communication mode of the single cell refers to a mode in which the wireless access network utilizes the communication resources of a single cell to communicate with the terminal. The communication resources include a frequency, a timeslot, and a code channel.

For example, the communication mode combination module 402 may transmit downlink service data by means of the communication mode of the softer handoff group and transmit at least one downlink control signaling by means of the communication mode of the single cell. Or, the communication mode combination module 402 may transmit uplink service data by means of the communication mode of the softer handoff group and transmit at least one uplink control signaling by means of the communication mode of the single cell.

The above embodiments are merely intended to describe the technical solutions of the present invention, but not to limit the scope of present invention. It will be apparent to those skilled in the art that various modifications and variations can be made to the present invention without departing from the scope or spirit of the invention.

What is claimed is:

1. A communication method based on a plurality of softer handoff groups, comprising:
dividing various services into different characteristic services according to characteristics of the services; and
selecting at least one softer handoff group as a serving cell of a terminal according to characteristic services subscribed by the terminal.

2. The communication method of claim 1, wherein the characteristics of the services comprise at least one of a bandwidth, a quality of service, and a real-time capability.

3. The communication method of claim 1, wherein the selecting at least one softer handoff group as a serving cell of a terminal comprises:
selecting a plurality of softer handoff groups with a number corresponding to that of the characteristic services as the serving cell of the terminal.

4. The communication method of claim 1, wherein the selecting at least one softer handoff group as a serving cell of a terminal comprises:
selecting a softer handoff group with cells having light loads as the serving cell of the terminal, as for a data service with a large bandwidth.

5. The communication method of claim 1, further comprising: transmitting the characteristic services between the terminal and each of base stations within the selected serving cell, wherein the transmitting the characteristic services comprises at least one of the following:
sending, by the terminal, at least one characteristic service data over a channel resource by means of at least one channel multiplexing mode, and determining, by each of the base stations, a softer handoff group to which the characteristic service data belong according to a corresponding channel resource so as to demodulate corresponding data; and
sending, by each of the base stations, at least one characteristic service data over the channel resource by means of the at least one channel multiplexing mode, and determining, by the terminal, the softer handoff group to which the characteristic service data belong according to the corresponding channel resource so as to demodulate the corresponding data.

6. The communication method of claim 1, further comprising:
selecting at least one of a softer handoff group and a single cell as the serving cell for transmitting at least one of uplink data and downlink data of the characteristic services of the terminal.

7. The communication method of claim 6, wherein the selecting at least one of a softer handoff group and a single cell as the serving cell for transmitting at least one of uplink data and downlink data of the characteristic services of the terminal comprises one of the following:
selecting the softer handoff group as the serving cell for transmitting the uplink data and selecting the single cell as the a serving cell for transmitting the downlink data; and
selecting the single cell as the serving cell for transmitting the uplink data and selecting the softer handoff group as the serving cell for transmitting the downlink data.

8. The communication method of claim 1, further comprising:
transmitting at least one of at least one control signaling and service data of the characteristic services by means of a communication mode of one of the softer handoff group and a single cell.

9. The communication method of claim 8, wherein the transmitting one of at least one control signaling and service data of the characteristic services by means of a communication mode of one of the softer handoff group and a single cell comprises at least one of the following:
transmitting downlink service data by means of the communication mode of the softer handoff group, and transmitting at least one downlink control signaling by means of the communication mode of the single cell; and
transmitting uplink service data by means of the communication mode of the softer handoff group, and transmitting at least one uplink control signaling by means of the communication mode of the single cell.

10. A communication system based on a plurality of softer handoff groups, comprising:
a characteristic service determination module, adapted to divide various services into different characteristic services according to characteristics of the various services; and
a serving cell selection module, adapted to select at least one softer handoff group as a serving cell of a terminal according to characteristic services subscribed by the terminal.

11. The communication system based on a plurality of softer handoff groups according to claim 10, further comprising:
at least one characteristic service data transmission module, arranged on one of a terminal side and a base station side, and adapted to send at least one characteristic service data over a channel resource by means of at least one channel multiplexing mode from one of the terminal side and the base station side and determine the at least one softer handoff group to which the characteristic service data belong according to a corresponding channel resource on the other one of the terminal side and the base station side, so as to demodulate corresponding data.

12. A data transmission method based on a plurality of softer handoff groups, comprising: selecting at least one softer handoff group as a serving cell for transmitting at least one of uplink data and downlink data of terminal services.

13. The data transmission method according to claim 12, wherein the at least one softer handoff group comprises a single cell, and the single cell is a softer handoff group with only one cell.

14. The data transmission method according to claim 13, further comprising at least one of the following:
selecting the at least one softer handoff group as the serving cell for transmitting the uplink data and selecting the single cell as the serving cell for transmitting the downlink data; or
selecting the single cell as the serving cell for transmitting the uplink data and selecting the at least one softer handoff group as the serving cell for transmitting the downlink data.

15. A communication mode combination method based on a plurality of softer handoff groups, comprising: transmitting at least one control signaling and service data of terminal services by means of a communication mode of a softer handoff group and a communication mode of a single cell.

16. The communication mode combination method according to claim 15, wherein:
a wireless access network in the communication mode of the softer handoff group utilizes same resources of more than one cell to communicate with the terminal; and
the wireless access network in the communication mode of the single cell utilizes the communication resources of a single cell to communicate with the terminal.

17. The communication mode combination method according to claim 15, further comprising:
transmitting downlink service data by means of the communication mode of the softer handoff group and transmitting at least one downlink control signaling by means of the communication mode of the single cell.

18. The communication mode combination method according to claim 15, further comprising:
transmitting uplink service data by means of the communication mode of the softer handoff group and transmitting at least one uplink control signaling by means of the communication mode of the single cell.

19. A communication mode combination system based on a plurality of softer handoff groups, comprising: a communication mode combination module, adapted to transmit at least one control signaling and service data of terminal services by means of a communication mode of a softer handoff group and a communication mode of a single cell.
